(19) United States
(12) Patent Application Publication
(10) Pub. No.: US 2025/0333333 A1
(43) Pub. Date: Oct. 30, 2025

(54) SYSTEM AND METHOD FOR REMOVING PER- AND POLYFLUOROALKYL SUBSTANCES FROM GROUND WATER

(71) Applicant: South Central Connecticut Regional Water Authority, New Haven, CT (US)

(72) Inventors: James M. Hill, Cheshire, CT (US); Jesse F. Culbertson, Bethany, CT (US); Sherwin Gormly, Oxford, CT (US)

(21) Appl. No.: 19/195,425

(22) Filed: Apr. 30, 2025

Related U.S. Application Data
(60) Provisional application No. 63/640,438, filed on Apr. 30, 2024.

(51) Int. Cl. C02F 1/28; B01D 15/22; B01D 29/27; C02F 1/00; C02F 101/30; C02F 101/36; C02F 103/06

(52) U.S. Cl. CPC C02F 1/283; B01D 15/222; B01D 29/27; C02F 1/001; B01D 2201/184; C02F 2101/308; C02F 2101/36; C02F 2103/06; C02F 2201/005; C02F 2209/11

(57) ABSTRACT

A system for decontamination of ground water containing one or more per- and polyfluoroalkyl substances (PFAS) at water treatment plants includes a powder activated carbon (PAC) module in fluid communication with a source of water containing the PFAS, wherein the PAC module comprises at least one bag filter pre-filled with the powder activated carbon, and a filter ripening module positioned downstream of the PAC module and configured to capture excess color and turbidity, wherein the powder activated carbon has a particle size of at least about 1 micron.

### FIELD OF THE TECHNOLOGY

The present technology relates to a system and method for removing per- and polyfluoroalkyl substances from ground and surface water. In particular, the technology relates to a system and method for removing per- and polyfluoroalkyl substances using a powder activated carbon system.

### BACKGROUND OF THE INVENTION

Per- and polyfluoroalkyl substances (PFAS) are a class of man-made compounds that have been used to manufacture consumer products and industrial chemicals. PFAS, including perfluorooctanoic acid (PFOA) and perfluorooctanesulfonic (PFOS) and other telomeres, may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. PFAS have been detected in surface waters, groundwaters, wastewaters, and drinking water sources.

PFAS can accumulate in wildlife and humans because they typically remain in the body for extended periods of time. More recently, long-chained PFAS in particular have been shown to bioaccumulate, persist in the environment, and be toxic to animals, wildlife, and humans. Laboratory PFAS exposure studies on animals have shown problems with growth and development, reproduction, and liver damage. Additionally, PFAS are highly soluble in water, result in large, dilute plumes, and have a low volatility.

PFAS have a unique chemistry. The molecular structure of most PFAS compounds can be broken into two functional units including the hydrophobic non-ionic tail comprised of the fluorinated carbon chain and the hydrophilic anionic head having a negative charge. The carbon-fluorine bond is one of the strongest bonds in nature and it is highly resistant to breakdown. As a result, PFAS are extremely stable compounds. The strength of the carbon-fluorine bond makes PFAS resistant to conventional water treatment methods. The vast majority of available conventional water treatment systems and methods to remove PFAS from water have proven to be expensive and inefficient, and do not provide cost-effective results.

One of the possible approaches to the removal of PFAS from water is use of powdered activated carbon (“PAC”) treatment systems. There are a number of existing PAC-based systems designed for removal of PFAS from water. For example, U.S. Ser. No. 11/905,187 describes a system and method for increasing removal of PFAS from ground and drinking water by using a sub-micron powder activated carbon (“SPAC”) with less than 1 micron particle size. The system includes an influent line that introduces the flow of influent of water to be treated into the system. SPAC is added to the influent via a SPAC feed line, typically using a carbon feed assembly or a SPAC slurry feed assembly. The SPAC/SPAC slurry and influent slurry is then pumped by a feed pump through slurry feed line to a sorption reactor. The SPAC with adsorbed contaminants and bulk liquid slurry is transferred from sorption reactor to the ceramic membrane filter for filtration. This system has a number of disadvantages. It requires use of sub-micron PAC, which is more expensive as it requires a specialized production process. Because of the use of SPAC, which has a smaller particle size, the system requires more advanced down-the-stream filtration system—i.e., a ceramic membrane—to provide sufficient filtration. The system also requires a use of a sorption reactor to extend contact time between SPAC and PFAS contaminated water, which in turn makes the system more complex and less efficient.

WO2024044860 discusses a method of removing PFAS contaminants from a water media, e.g., ground water, which includes introducing nanobubbles into the water media to cause foam fractionation. The method may include an additional step of pumping the treated water through a GAC or PAC column in a continuous flow-through mode to adsorb contaminants. This method focuses primarily on foam fractionation process to remove PFAS and mentions the use of PAC only as an optional step.

U.S. Ser. No. 11/780,746 and WO2025043303 describe a low-energy method of dewatering highly contaminated waste contaminated with various contaminants and PFAS. The method is primarily focused on a foam fractionation/floatation method to remove PFAS and only mentions use of PAC as an additional optional step. The described method is complex, expensive and difficult to scale for large-scale water treatment facilities with million gallons per day (MGD) flow rates.

WO2025054446 discusses an in-situ method of degradation of PFAS in soil and groundwater using an oxidant such as peroxygen compounds. The method includes adding activated carbon such as PAC or GAC to contaminated water, allowing PFAS to fix to the activated carbon for more than 24 hours, and adding an oxidant reactive to the activated carbon to initiate degradation of PFAS wherein the sorptive media is at least 65 degrees C. This method focuses on in-situ water treatment and thus is not suitable for commercial water treatment facilities.

Therefore, there is still an urgent need for methods and systems capable of treating PFAS contaminated ground and surface water utilizing PAC in a more efficient and cost-effective way that are particularly suitable for large-scale commercial water treatment facilities.

### SUMMARY OF THE INVENTION

Various illustrative embodiments for an improved system and method for removing PFAS from ground water are described herein. The present technology is particularly suitable for removing PFAS from groundwater processed by ground water treatment plants.

A system for removing per- and polyfluoroalkyl substances (PFAS) from ground water is featured. The system includes a powder activated carbon (PAC) module in fluid communication with a source of water containing the PFAS, wherein the PAC module has at least one bag filter pre-loaded with the powder activated carbon in a range of about 10% to about 60% of a total bag filter volume and wherein the powder activated carbon has a particle size of at least about 1 micron.

In some embodiments, the at least one bag filter has a pore size of about 10 micron or less.

In certain embodiments, the powder activated carbon has a particle size of at least about 10 microns.

In some embodiments, the at least one bag filter is pre-filled with the powder activated carbon in a range of about 25% to about 75% of a total bag filter volume.

In some cases, the PAC module further comprises a metering device for supplying the powder activated carbon to one of the at least one bag filter.

In some embodiments, the PAC module accommodates a flow rate through the at least one bag filter of about 1 gallons/min to about 50 gallons/min.

In certain embodiments, the system is configured to remove the PFAS from water having a concentration of PFAS in a range of about 4 parts per trillion (ppt) to about 100 ppt.

A system for decontamination of water containing one or more per- and polyfluoroalkyl substances (PFAS) is also provided including a powder activated carbon (PAC) module in fluid communication with a source water, wherein the PAC module is configured to supply a powder activated carbon to water, wherein the powder activated carbon has a particle size of about 1 micron or more, and a filter ripening module positioned downstream of the PAC module and configured to capture excess color and turbidity.

In some embodiments, the system further includes a contactor module configured to allow additional contact time between the powder activated carbon and PFAS in water.

In some cases, the PAC module includes at least one bag filter prefilled with the powder activated carbon in a range of about 25% to about 75% of a total bag filter volume. In certain of these embodiments, the PAC module includes a metering device configured to supply the powder activated carbon to the at least one bag filter and/or an influent water stream to the bag filter.

In some embodiments, the PAC module has a mixing system for continuously mixing the supplied powder activated carbon with water.

In some embodiments, the system also includes a turbidity meter positioned downstream from the PAC module and configured to measure turbidity of water from the PAC module. In certain of these embodiments, the filter ripening module includes a vessel, at least one filter positioned downstream of the vessel and a first valve positioned upstream of the vessel. In additional embodiments, a second valve positioned downstream of the turbidity meter. In further of these embodiments, the system includes a processor configured to receive turbidity measurements from the turbidity meter, compare the received turbidity measurements to a predetermined threshold, initiate a ripening mode if the received turbidity measurements are above the predetermined threshold by closing the second valve and opening the first valve to direct an effluent flow of water from the PAC module to the filter ripening module, and initiate a production mode if the received turbidity measurements are within the predetermined threshold by closing the first valve and opening the second valve to direct an effluent flow of water from the PAC module to a clear-well bypassing the filter ripening module. In additional embodiments, the processor is configured to initiate a ripening mode when one or more fresh filters are installed in the filter ripening module, receive turbidity measurements from the turbidity meter, compare the received turbidity measurements to a predetermined threshold, and initiate a production mode if the received turbidity measurements are within the predetermined threshold by closing the first valve and opening the second valve to direct an effluent flow of water from the PAC module to a clear-well bypassing the filter ripening module.

In another aspect of the invention, a method for decontamination of ground water containing one or more per- and polyfluoroalkyl substances (PFAS) is provided. The method includes the steps of supplying water from a ground water source via one or more pump systems, providing at least one bag filter pre-loaded with a powder activated carbon, wherein the powder activated carbon has a particle size of about 1 micron or more, passing water through the at least one bag filter to capture the PFAS, and supplying a stream of water free of the PFAS for further processing.

In some embodiments, the method also includes the step of dosing the powder activated carbon to the at least one bag filter and/or an influent water stream to the bag filter via a metering device, wherein a dosing rate is dependent on a water flow rate and a concentration of the PFAS in the influent water stream.

In certain embodiments, the method includes the step of allowing additional contact time between the powder activated carbon and water by passing the water mixed with the powder activated carbon through a contactor module.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

Further objects, aspects, features, and embodiments of the present technology will be apparent from the drawing Figures and below description.

### BRIEF DESCRIPTION OF THE DRAWINGS

FIG. 1 is a schematic block diagram showing an exemplary embodiment of the system and method for removing PFAS from ground water.

FIG. 2 is a schematic block diagram showing an exemplary embodiment of a powder activated carbon module.

FIG. 3 is a schematic block diagram showing a portion of an exemplary embodiment of the system for removing PFAS from ground water.

FIG. 4 is a schematic view of an exemplary embodiment of a bag filer module.

FIG. 5 illustrates an exemplary embodiment of a bag filter.

### DETAILED DESCRIPTION OF THE INVENTION

The following detailed description is merely exemplary in nature and is not intended to limit the disclosed invention or any associated methods for producing or using the same described herein. Furthermore, there is no intention to be bound by any theory presented in the preceding background or the following detailed description.

It is noted that, as used in the specification and the claims, the singular form “a,” “an,” and “the” comprises plural referents unless the context clearly indicates otherwise. For example, reference to a component in the singular is intended to comprise a plurality of components.

The term “about” is to be construed as modifying a term or value such that it is not an absolute. This term will be defined by the circumstances. This includes, at the very least, the degree of expected experimental error, technique error and instrument error for a given technique used to measure a value. In general, this term used in connection with a numerical value throughout the specification and the claims denotes an interval of accuracy, familiar and acceptable to a person skilled in the art. In general, such interval of accuracy is ±10%. Thus, “about ten” means 9 to 11.

All numbers in this description indicating amounts, ratios of materials, physical properties of materials, or use are to be understood as modified by the word “about,” except as otherwise explicitly indicated.

“At least one”, as used herein, relates to one or more, i.e., 1, 2, 3, 4, 5, 6, 7, 8, 9, or more.

The term “comprising” and “comprises” is synonymous with “including,” “having,” “containing,” or “characterized by.” These terms are inclusive and open-ended and do not exclude additional, unrecited elements or method steps.

Various illustrative embodiments for an improved system and method for removing PFAS from ground water in water treatment plants are described herein. The present technology is particularly suitable for removing PFAS from ground water where the concentration of PFAS in water is in a range of about 4 parts per trillion (ppt) to about 100 ppt. A concentration of one part per trillion means that there is one part of PFAS for every one trillion parts of water in which it is contained. One part per trillion is equivalent to one nanogram per kilogram.

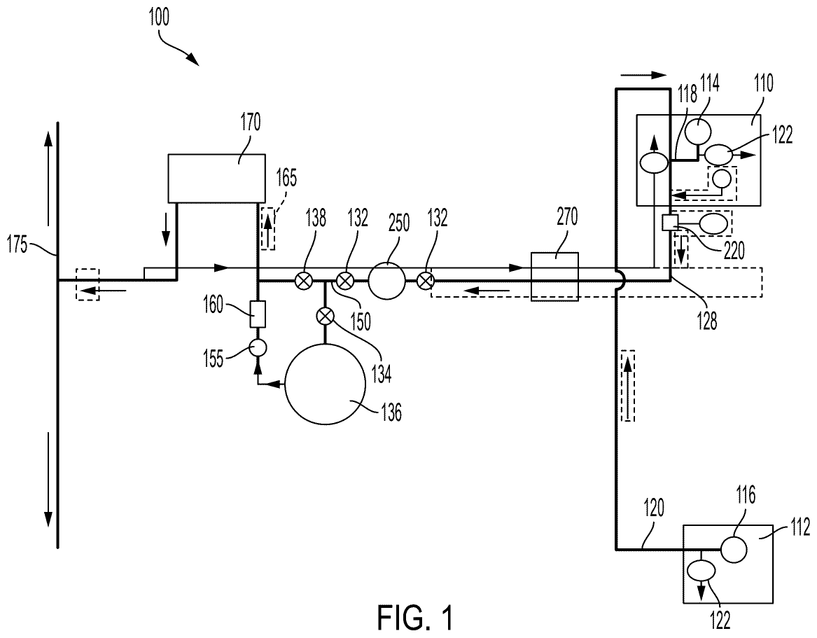

FIG. 1 shows an exemplary embodiment of a system 100 for removing PFAS from ground water. At the start of the process, water is pumped from an aquifer via one or more pumps. As illustrated in FIG. 1, water may be pumped from first well 110 by pump 114 or from second well 112 by pump 116, or both together, via water output lines 118, 120. Any suitable types of pumps may be used in this step, including pumps already in place at a water treatment plant facility. In some embodiments, the system may also include raw water sampling points 122 positioned in the water output lines downstream from the well pumps.

The system 100 further includes a powder activated carbon (PAC) module. The PAC module utilizes powder activated carbons to remove PFAS from water being treated. Powder Activated Carbons are classified as PAC by AWWA Standard B600-05 if not less than 90% by mass passes through a 44-μm sieve. Wood-based carbons are an exception and are classified as PAC if not less than 60% by mass passes through a 44-μm. PAC effective size is smaller than Granular Activated Carbon (GAC) but larger than superfine powder activated carbon (SPAC). In some embodiments, the present system uses PAC with a particle size of about 1 micron or more. In additional embodiments, PAC with a particle size of about 10 microns or more may be used. In additional embodiments, PAC with a particle size of about 5 microns to about 150 microns may be used, or about 15 microns to about 50 microns. PAC can be produced from a variety of organic feedstocks, such as wood, coconut shells, bituminous coal, and lignite. The raw material is turned into a char by pyrolytic carbonization and then oxidized to develop the internal pore structure. The internal pore structure is what provides the large surface area that makes activated carbon effective for water treatment. Activation, the development of the internal pore structure, is commonly accomplished in two ways: chemically or thermally. Thermal activation occurs at temperatures between 800 and 900° C. with oxidizing gases such as steam and/or carbon dioxide. Chemical activation is accomplished by heating the raw material with phosphoric acid in the absence of oxygen.

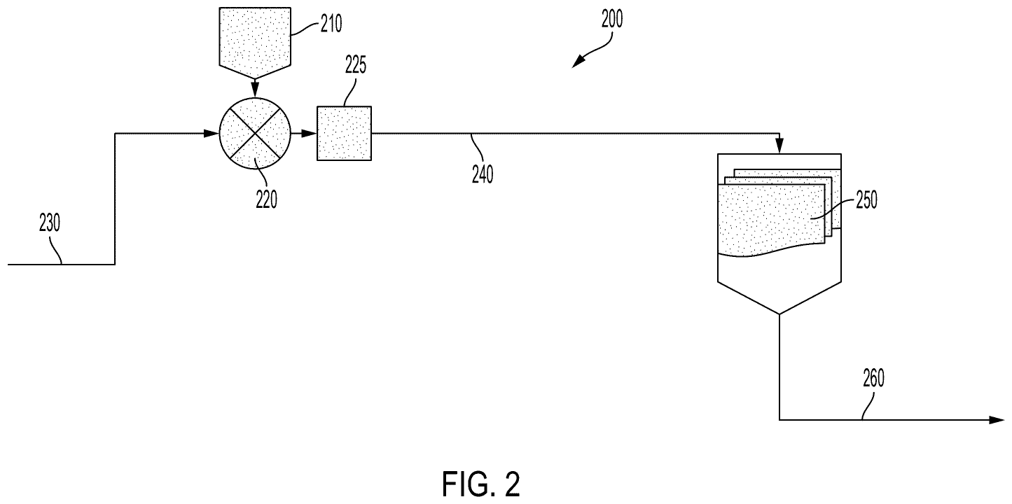

One exemplary embodiment of the PAC module is shown in FIG. 2. The PAC module 200 has a PAC reservoir 210. Any suitable reservoir may be used. In some embodiments, a VOC-grade reservoir is used that is a specialized storage container design to hold substances with a high content of volatile organic compounds. The reservoir 210 functions to contain an amount of PAC used by the PAC module. The PAC reservoir 210 is coupled to a metering device 220 through which PAC is supplied. PAC may be introduced as a dry power, a slurry and/or a solution. In some embodiments, PAC is introduced as a slurry and may be fed with a positive displacement pump. The positive displacement pump moves a fluid by repeatedly enclosing a fixed volume and moving it mechanically through the system. The pumping action is cyclic and may be driven by pistons, screws, gears, rollers, diaphragms or vanes. In additional embodiments, PAC is introduced as a dry powder. In the embodiment shown in FIG. 2, the metering device 220 feeds PAC into a water process line 240 that transports a mixture of PFAS containing water and PAC.

In some embodiments, the pumps may include a flowmeter with predetermined alarm parameters. If the flowmeter detects a feed failure based on the predetermined parameters, it would signal the system to stop the PFAS removal process. In some embodiments, the flowmeter may send signals regarding the PAC flow to a system processor, which will process the signals and determine if they meet predetermined alarm parameters. If so, the processor sends an alarm signal to the system to stop the PFAS removal.

In some embodiments, a PAC mix module 225 may be provided. The PAC mix module may be a PAC mix tank with the PAC feed pump. The PAC mix module may include a continuous mixing mechanism to prevent excessive settling of PAC and aid in providing a consistent PAC dose in the water. Depending on the application, the chemicals and PAC may be mixed via an in-line rapid mixer or a static mixer. The amount of PAC added to water may depend on a desired concentration of PAC, a concentration of PFAS in water, water flow rate, a size of water tank, duration of contact between PAC and water, etc. In some embodiments, a desired concentration of PAC in water is about 0.1-25% by weight, or about 1-20% by weight, or about 5-15% by weight, or about 11%.

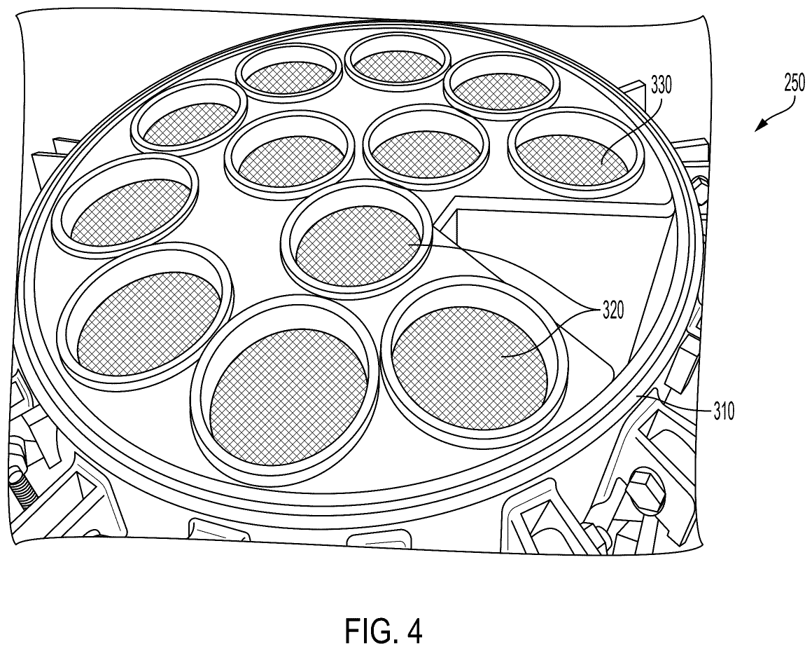

In some embodiments, PAC module 200 further includes a PFAS filtration module 250. The mixture of PFAS containing water and PAC in transported to the PFAS filtration module 250 vie the water process line 240. In one exemplary embodiment shown in FIG. 4, the PFAS filtration module 250 is a vessel 310 containing one or more bag filters 320 loaded into the vessel. The vessel 310 is made with stainless steel, carbon steel, plastic or other suitable materials. Any number of bag filters may be provided in the vessel, as desired. In some embodiments, the vessel includes 1-100 bag filters, or 5-50 bag filters, or 10-30 bag filters, or 12 bag filters. A higher number of bags is preferrable for high-flow applications or continuous industrial processes.

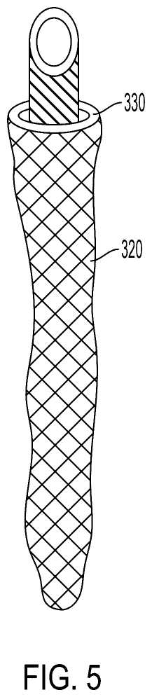

Any type of a PAC filter suitable for drinking water may be used. One example of a bag filter is shown in FIG. 5. The bag filter 320 has a hollow elongated body comprised of a nonwoven or woven fabric. The bag filter is made with any suitable synthetic or natural material, including but not limited to polyester, polypropylene, and nylon mesh. The filter bag material has a plurality of holes/pores that let water through but retain PAC particles inside the hollow bag filter. In some embodiments, the pore size is about 0.1-100 micron, or about 1-10 micron, or about 1-5 micron, or about 5 micron, or about 1 micron. Water flows from the inside of the bag to the outside under certain pressure, forcing it through the filter media. As it flows, PAC particles are captured by the bag material (either on the surface or within the depth of the material). The filtered water then collects in the vessel's bottom chamber. The filtered water exits through the outlet port, typically located at the bottom or side of the vessel. The bag filters 320 are provided with a seal or ring (snap-ring, flange, or drawstring) 330 at the top of the bag to ensures a leak-proof fit to prevent bypass of water. A support basket or mesh cylinder may be provided to support the bag inside the vessel, which prevents collapse under water pressure. The vessel 310 has a lid, preferably with a seal or ring, to ensure a tight seal under pressure. When in use, the bags filter 320 are inserted into the vessel 310. The lid is placed on top of the housing and tightened with e.g., screws, clamps, swing bolts, or a locking ring, to compress the ring. This compression creates a seal that prevents untreated water from leaking out, keeps unfiltered water from bypassing the filter bags, and allows the system to operate under pressurized conditions, e.g., up to 150 psi or more. The pressure differential on the filter membrane may be up to about 40 psi. In some exemplary embodiments, the vessel with the bag filters may have a capacity volume of about 150 gallons to about 200 gallons of water. Each of the bag filters may have a capacity of about 0.5 to about 10 pounds of PAC, or about 1 to about 8 pounds of PAC, or about 3 to about 5 pounds of PAC. Each bag filter 320 that is half filled with PAV has a capacity to absorb about 0.01 g to about 1 g of PFAS, or about 0.1 g to about 0.5 grams of PFAS. The present invention achieves effective PFAS removal with a flow rate of about 1 gallons/min to about 50 gallons/min, or about 30 gallons/min per bag filter 320, and a flow rate of about 200 to about 1000 gallons/min, or about 500 to about 700 gallons/min total for the vessel.

In some exemplary embodiments, the bag filters 320 in the PFAS filtration module 250 may be preloaded with PAC. In other words, the filter bags are loaded with PAC before they are installed in the PFAS filtration module 250 and the system is run. One or more of the filter bags 320 may be preloaded with PAC in a range of about 10% to about 100% and preferably about 25% to about 75% of a total bag filter volume, and more preferably about 50% of a total bag filter volume. Fluidizing the PAC media bed and mixing occurs within the bag filter voids. Once PAC media in the bag filters is depleted during the water treatment process, the vessel may be opened, the bags are removed and replaced with new PAC pre-filled bags.

In additional embodiments, the PAC module 200 may provide for continuous dosing of PAC into the bag filters. This may be implemented in place of PAC pre-filled filter bags or in addition to the use of PAC pre-filled filter bags. PAC may be added to the bag filters in a dry form or a slurry form. For example, PAC is supplied from a reservoir containing an amount of PAC, mixed with water into a slurry, optionally mixed with a mechanical mixer to keep the slurry suspended and supplied to a metering device such as a metering pump, which injects the PAC slurry into the bag filters 320. PAC feed rate may flow-paced and adjust automatically based on water flow rate through the plant. The system may be configured to monitor real-time flow rate of water and the metering device may be configured to adjust output of PAC into the bag filter to maintain the desired PAC dose based on current flow. In additional embodiments, the PAC feed rate may be set and/or adjusted manually by a user.

When in use, the system may automatically measure the amount of PAC in the bag filer and signal when there is too much PAC so that the bag filter needs to be removed and replaced with another bag. This may be achieved by measuring a differential pressure on the bag filter indicating how plugged the filter is. The system may utilize preset parameters—e.g., a predetermined threshold—for pressure differential on the bag filter and compare the threshold to the continuously measured differential pressure measurements. Once the predetermined threshold has been reached, the system will signal/notify the use that the bag filter needs to be replaced. The system may have two manual valves 132 as shown in FIG. 1—one on either side of the PAC module 250. When the system signals that it is necessary to clean and/or replace PAC bag filters 320, the valves 132 are closed such that no water is flowing through. After the replacement/cleaning cycle is completed, the valves 132 are opened to resume flow of water through the PAC module 250.

In additional embodiments, the system may be provided with a clean-in-place system for PAC bag filters. The clean-in-place system is designed to clean the bag filters without the need to remove them from the filtration module. A pump 170, such as a backflush pump, may be fluidly connected to the PFAS filtration module 250 and may be used to circulate water and/or cleaning agents through the vessel 310 and the bag filters 320 to dislodge and flush out PAC media from the bag filters. The backflush water with PAC media is then pumped out of the vessel and into a drain tank. Fresh PAC media may then be metered into the filter bags 320.

It is understood that the PAC feed into the water line prior to the PFAS filtration module 250, as described above, may be omitted. In some exemplary embodiments, PAC is provided only in pre-filled bag filters and/or is continuously fed into the bag filters. In the embodiments where the PAC module includes only PAC pre-filled bag filters, the PAC reservoir, PAC mixing module and PAC metering device are not necessary and may be omitted. The water 260 existing the PFAS filtration module 250 is PFAS free and flows through the remainder of the water treatment system, as described below.

The present inventors have discovered unexpectedly that the bag filter configuration is successful and effective for PFAS removal and constraining PAC, without the need for more complex filtration systems. Without wishing to be bound by any particular theory, the present inventor discovered that the PAC particles fill against the bag filter walls and thus attribute to the filtration properties of the bag filter. Additionally, water containing PFAS is forced through a layer of PAC in the bag filter, thus forcing contact between the PFAS particles and PAC particles. The present invention provides a highly robust, more energy efficient, and simpler filter style that has not been previously perceived as effective for this application. Employing initial PAC loading into bag filters, with or without in line metered PAC addition, as opposed to traditional bulk loading of the contactor for PFAS removal allows for continuous filter loading control as well as optimal PAC/PFAS contact.

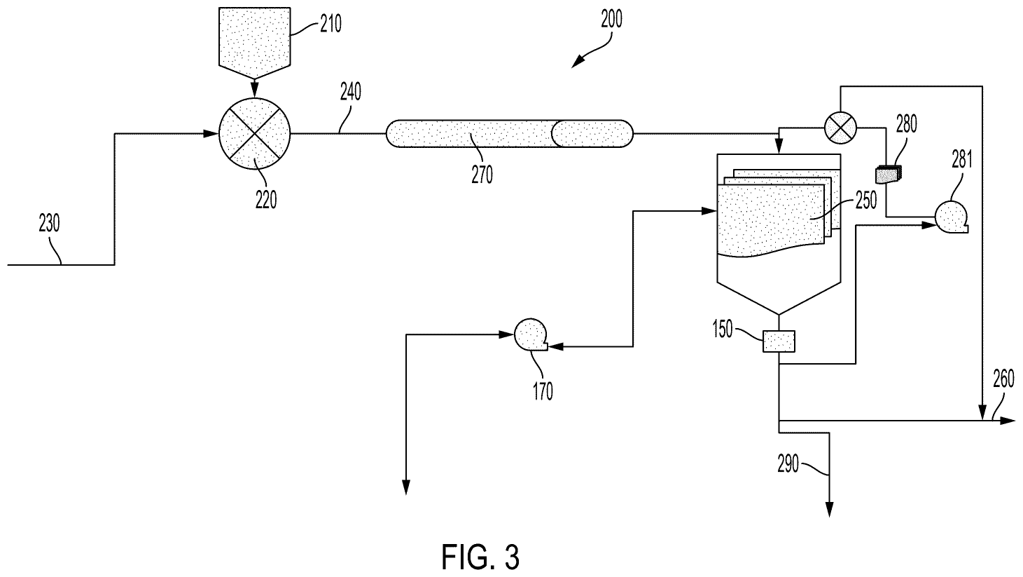

In certain exemplary embodiments, the system also includes a PAC contactor module 270, as shown in FIG. 3. The PAC contactor module 270 may include a contactor which allows additional contact time between the PAC and PFAS compounds in the water. The PFAS require contact time with the PAC for effective removal. After passing the PAC metering device and/or the mix module, the chemically treated water flows through the contactor. The size of the contactor may be dependent on PFAS concentration and type, water flow rate, type of PAC and temperature. During this step of the process, the majority of PFAS may be absorbed into the PAC and removed from the water. In some embodiments, the minimum contact time between water with PFAS and PAC is at least about 30 minutes or at least about 1 hour, or at least about 2 hours. In additional embodiments, the contact time between water with PFAS and PAC is between about 30 minutes to about 2 hours. After the contactor module 270, the treated water flows into PFAS filtration module 250 described above.

Any suitable turbidity meter known in the art may be used. The turbidity meter will measure turbidity of the effluent water from the PAC mixing tank and compare it to predetermined parameters. If the water turbidity is below a predetermined threshold, it means that a part of the PAC feed process failed. The turbidity meter may then generate alarm signals to the system to stop the PFAS removal process.

PAC typically affects the effluent turbidity of the water. The system may include a turbidity meter 150 positioned in the effluent of the PFAS filtration module 250. In some embodiments, the system may also include a turbidity meter 128 positioned in the effluent of the PAC mixing tank 220. Any suitable turbidity meters known in the art may be used. The turbidity meters will measure turbidity of the effluent water from the PFAS filtration module 250 and/or PAC mixing tank 220 and compare it to predetermined parameters. If the water turbidity is below a predetermined threshold, it means that all or a part of the PAC feed process failed. The turbidity meters may then generate alarm signals to the system to stop the PFAS removal process.

Since feeding PAC into the raw water raises the turbidity levels beyond regulatory standards, filtration may be required, and the system may include a filtration module as the next step in the process. The turbidity meter 150 may measure turbidity of the effluent water to ensure turbidity within regulatory standards for compliance purposes. If the turbidity is above the regulatory standards, the effluent water from the PFAS filtration module 250 is sent to a filter ripening module 280 for further filtration of PAC. The filter ripening module 280 may contain one or more polishing filters 155 of any suitable type, such as cartridge filters, bag filters, fine media filters, membrane filters, etc. The filters 155 may be of any suitable size, such as about 0.1 to about 5 microns, about 0.2 to about 5 microns, or about 0.5 microns. The filter ripening module 280 further includes a filtration tank 136 that collects turbid water from the PFAS filtration module 250. Water captured in the tank 136 can be filtered back by the polishing filters 155 below regulatory limits and pumped to the treated water stream 165 via a pump 160, as shown in FIG. 1. The system may also include a first automated valve 138 and a second automated valve 134. The automated valved function to switch the system from a ripening mode to a production mode. If the turbidity measurement from the turbidity meter 150 is above the regulatory standards, the system will go into a ripening mode, where the first automated valve 138 will close and the second automated valve 134 will open, directing the effluent water stream from the PFAS filtration module 250 to the filtration tank 136 of the filter ripening module 280 for further filtration. Once the turbidity measurement from the turbidity meter 150 falls within the regulatory standards, the system will switch to the production mode, where the second automated valve 134 will close and the first automated valve 138 will open, directing the effluent water stream from the PFAS filtration module 250 to the finished water flow 165 leading to clearwell 170 and bypassing the filter ripening module 280.

Once the water in the filter ripening module 280 is brough to acceptable turbidity levels, it will slowly pumped back into the finished water flow 165. This design achieves better system efficiency as it does not require the turbid water to be discarded, but instead feeds the filtered water back into the system. However, in some embodiments, the water from the filter ripening module 280 may be pumped out to e.g., a waste water treatment facility via the line 290.

In some embodiments, the system may be configured to automatically start in a ripening mode after new powdered activated carbon is added to the PAC module, regardless of the measurements from the turbidity meter 150. Once the measurements received from the turbidity meter 150 fall within the regulatory standards, the system will switch to the production mode, as discussed above.

Various chemicals may be introduced during the water treatment process, including, but not limited to, phosphate, fluoride, powder activated carbon, and chlorine. The chemicals may be introduced in a form of dry powder, a slurry, and/or a solution. These chemicals may be added directly into the finished water flow 165 from the output lines after PAC addition and filtration. The chemicals may be added using one or more positive displacement chemical metering pumps or any other suitable pumps. The pumps may use control based on the raw water flow rate (flow paced) and receive a signal from a flow meter and react by increasing or decreasing the dosing rate. The flow meters may be installed in-line with the dosing pumps to guarantee accurate flow-pace dosing.

In some embodiments, phosphate is introduced into the finished water flow 165. Phosphate may be used to prevent the release of metals. Orthophosphate is most commonly used for lead and copper control. Polyphosphates sequester iron and manganese to prevent discolored water. Blended phosphates are a mix of orthophosphate and polyphosphate, which can potentially provide both sequestration and corrosion control.

Because PAC will absorb free chlorine, sodium hypochlorite may be injected into water after it passes the PFAS filtration module and filter ripening module. At this stage, the water should contain minimal, or no amounts of PAC and sodium hypochlorite will effectively provide a free chlorine residual. Further, fluoride, such as e.g., fluorosilicic acid, may also be injected into the water at this stage. Sodium hypochlorite and/or fluoride may be supplied into filtration module effluent via a positive displacement chemical metering pump, or any other suitable pump known in the art.

Next, the water flows into the clear-well 170 and is ready to be pumped into the water distribution system 175 for use. Before the water is pumped into the water distribution system, corrosion control chemicals may be injected into the water via a positive displacement pump or any other suitable pump.

The system of the present invention may include one or more sensors/analyzers used to determine and monitor water quality at various stages of the process.

Table 1 below summarizes test results from various embodiments of the PFAS removal system and method of the present invention.

The testing was performed in accordance with EPA 537.1, Revision 2.0, available from the U.S. Environmental Protection Agency (EPA). This test is designed for detecting certain per- and polyfluoroalkyl substances (PFAS) in drinking water. The method targets 18 PFAS compounds, including PFOA (Perfluorooctanoic acid), PFOS (Perfluorooctanesulfonic acid), PFHxS, PFHpA, PFBS, GenX (HFPO-DA), and others.

Water samples are collected in polypropylene bottles (glass avoided to reduce PFAS adsorption) and preserved with Trizma® buffer to control pH. Next, solid phase extraction (SPE) is performed to concentrate and isolate PFAS from the water sample, followed by elution of the extracted compounds using methanol and further concentration. Then, liquid chromatography/tandem mass spectrometry (LC-MS/MS) analysis is performed, and results are quantified and reported in parts per trillion.

TABLE 1

| Test | | | | |
|---|---|---|---|---|
| Sample No. | Test Sample Description | PFAS | Results | Sample Location |
| 1 | Raw water sample from well | Detected | Not acceptable | Raw sample tap |
| 2 | ½ pre-filled bag filter | Not detected | Acceptable | (2) 5-micron |
| | with PAC, water flow | | | primary bag filters |
| | rate 300 gallons/min | | | and (2) 0.5-micron |
| | | | | secondary filters |
| 3 | ½ pre-filled bag filter | Not detected | Acceptable | (2) 5-micron |
| | with PAC, water flow | | | primary bag filters |
| | rate 555 gallons/min | | | and (2) 0.5-micron |
| | | | | secondary filters |
| 4 | Full pre-filled bag filter | Not detected | Acceptable | (2) 5-micron |
| | with PAC, water flow | | | primary bag filters |
| | rate 346 gallons/min | | | and (2) 0.5-micron |
| | | | | secondary filters |
| 5 | Metered 11% by | Minimal amounts | Acceptable | (1) 5-micron |
| | weight solution, 20 ppm | detected | | primary bag filters |
| | dose of PAC into bag | | | and (2) 0.5-micron |
| | filter, water flow rate | | | secondary filters |
| | 8 gallons/min | | | |
| 6 | ½ pre-filled bag filter | Not detected | Acceptable | Off-diffuser, no |
| | with PAC, water flow | | | secondary filters |
| | rate 300 gallons/min | | | |
| 7 | ½ pre-filled bag filter | Not detected | Acceptable | Off-diffuser, no |
| | with PAC, water flow | | | secondary filters |
| | rate 530 gallons/min | | | |
| 8 | ½ pre-filled bag filter | Not detected | Acceptable | Side stream filter - |
| | with PAC, water flow | | | (1) 5-micron |
| | rate 300 gallons/min | | | primary bag filter |
| | | | | and (2) 0.5-micron |
| | | | | secondary filters |

The above test results demonstrate the efficacy of the present system and method in successfully removing PFAS from water.

Although the invention has been described and illustrated with respect to exemplary embodiments thereof, it should be understood by those skilled in the art that the foregoing and various other changes, omissions and additions may be made therein and thereto, without parting from the spirit and scope of the present invention. It should also be understood that features described and illustrated in reference to one embodiment may be employed in other embodiments as appropriate.

What is claimed is:

1. A system for decontamination of ground water containing one or more per- and polyfluoroalkyl substances (PFAS) at water treatment plants, comprising:
a powder activated carbon (PAC) module in fluid communication with a source of water containing the PFAS, wherein the PAC module comprises at least one bag filter pre-loaded with the powder activated carbon in a range of about 10% to about 60% of a total bag filter volume;
wherein the powder activated carbon has a particle size of at least about 1 micron.

2. The system of claim 1, wherein the at least one bag filter has a pore size of about 10 micron or less.

3. The system of claim 1, wherein the powder activated carbon has a particle size of at least about 10 microns.

4. The system of claim 1, wherein the at least one bag filter is pre-filled with the powder activated carbon in a range of about 25% to about 75% of a total bag filter volume.

5. The system of claim 1, wherein the PAC module further comprises a metering device for supplying the powder activated carbon to one of the at least one bag filter.

6. The system of claim 1, wherein the PAC module accommodates a flow rate through the at least one bag filter of about 1 gallons/min to about 50 gallons/min.

7. The system of claim 1, wherein the system is configured to remove the PFAS from water having a concentration of PFAS in a range of about 4 parts per trillion (ppt) to about 100 ppt.

8. A system for decontamination of water containing one or more per- and polyfluoroalkyl substances (PFAS), comprising:
a powder activated carbon (PAC) module in fluid communication with a source water, wherein the PAC module is configured to supply a powder activated carbon to water, wherein the powder activated carbon has a particle size of about 1 micron or more, and
a filter ripening module positioned downstream of the PAC module and configured to capture excess color and turbidity.

9. The system of claim 8, further comprising a contactor module configured to allow additional contact time between the powder activated carbon and PFAS in water.

10. The system of claim 8, wherein the PAC module comprises at least one bag filter prefilled with the powder activated carbon in a range of about 25% to about 75% of a total bag filter volume.

11. The system of claim 10, wherein the PAC module comprises a metering device configured to supply the powder activated carbon to the at least one bag filter and/or an influent water stream to the bag filter.

12. The system of claim 8, wherein the PAC module comprises a mixing system for continuously mixing the supplied powder activated carbon with water.

13. The system of claim 8, further comprising a turbidity meter positioned downstream from the PAC module and configured to measure turbidity of water from the PAC module.

14. The system of claim 13, wherein the filter ripening module comprises a vessel, at least one filter positioned downstream of the vessel and a first valve positioned upstream of the vessel.

15. The system of claim 14, further comprising a second valve positioned downstream of the turbidity meter.

16. The system of claim 15, wherein the system further comprises a processor configured to:
receive turbidity measurements from the turbidity meter,
compare the received turbidity measurements to a predetermined threshold,
initiate a ripening mode if the received turbidity measurements are above the predetermined threshold by closing the second valve and opening the first valve to direct an effluent flow of water from the PAC module to the filter ripening module, and
initiate a production mode if the received turbidity measurements are within the predetermined threshold by closing the first valve and opening the second valve to direct an effluent flow of water from the PAC module to a clear-well bypassing the filter ripening module.

17. The system of claim 15, wherein the system further comprises a processor configured to:
initiate a ripening mode when one or more fresh filters are installed in the filter ripening module;
receive turbidity measurements from the turbidity meter,
compare the received turbidity measurements to a predetermined threshold, and
initiate a production mode if the received turbidity measurements are within the predetermined threshold by closing the first valve and opening the second valve to direct an effluent flow of water from the PAC module to a clear-well bypassing the filter ripening module.

18. A method for decontamination of ground water containing one or more per- and polyfluoroalkyl substances (PFAS), comprising the steps of:
supplying water from a ground water source via one or more pump systems,
providing at least one bag filter pre-loaded with a powder activated carbon, wherein the powder activated carbon has a particle size of about 1 micron or more,
passing water through the at least one bag filter to capture the PFAS, and
supplying a stream of water free of the PFAS for further processing.

19. The method of claim 18, further comprising the step of dosing the powder activated carbon to the at least one bag filter and/or an influent water stream to the bag filter via a metering device, wherein a dosing rate is dependent on a water flow rate and a concentration of the PFAS in the influent water stream.

20. The method of claim 18, further comprising the step of allowing additional contact time between the powder activated carbon and water by passing the water mixed with the powder activated carbon through a contactor module.
